(19) United States
(12) Patent Application Publication
(10) Pub. No.: US 2014/0288911 A1
(43) Pub. Date: Sep. 25, 2014

(54) SYSTEM AND METHOD FOR SIMULATING INTEGRATED CIRCUIT PERFORMANCE ON A MANY-CORE PROCESSOR

(71) Applicant: NVIDIA CORPORATION, Santa Clara, CA (US)

(72) Inventors: Lung Sheng Chien, Santa Clara, CA (US); Francesco Lannutti, I, Roma (IT)

(73) Assignee: Nvidia Corporation, Santa Clara, CA (US)

(21) Appl. No.: 13/850,059

(22) Filed: Mar. 25, 2013

(51) Int. Cl. G06F 17/50

(52) U.S. Cl. CPC G06F 17/5036
USPC 703/14

(57) ABSTRACT

A system, method and SPICE model evaluation module executable on a many-core processor. In one embodiment, the module includes: (1) a setup module operable to generate topology matrices T₁ and T₂, (2) a device evaluation/update module associated with the setup module and operable to generate and update source elements S_{A} for a matrix A and S_{b} for a right-hand-side vector b and (3) a generation module associated with the device evaluation/update module and operable to generate A using T₁ and S_{A} and further generate b using T₂ and S_{b}.

### TECHNICAL FIELD

This application is directed, in general, to circuit simulation and, more specifically, to a system and method for simulating integrated circuit (IC) performance on a many-core processor.

### BACKGROUND

SPICE (Simulation Program with Integrated Circuit Emphasis) is a computer program written about 40 years ago, significantly enhanced over the intervening years (i.e., SPICE1, SPICE2 and SPICE3 so far) and widely commercially available in open source and several proprietary variants. SPICE is fundamentally designed to simulate the operation of an IC by evaluating a model of it. Consequently, the IC can be tested and verified without being fabricated.

To evaluate an IC model, SPICE constructs a matrix A and a right-hand-side vector b for use in various (e.g., Newton-Raphson) numerical analyses. After constructing A and b, SPICE then iteratively (1) evaluates the devices in the IC and (2) updates A and b accordingly.

SPICE is enormously popular among IC developers and is expected to continue being so for the foreseeable future. It is expected that SPICE will become more accurate and encompass a growing variety of devices and fabrication technologies as time progresses. SPICE also benefits from executing on processors that have become faster, and memories that have become larger, over time.

### SUMMARY

One aspect provides a SPICE model evaluation module executable on a many-core processor. In one embodiment, the module includes: (1) a setup module operable to generate topology matrices T₁ and T₂, (2) a device evaluation/update module associated with the setup module and operable to generate and update source elements S_{A} for a matrix A and S_{b} for a right-hand-side vector b and (3) a generation module associated with the device evaluation/update module and operable to generate A using T₁ and S_{A} and further generate b using T₂ and S_{b}.

Another aspect provides a method of simulating IC performance on a many-core processor. In one embodiment, the method includes: (1) generating respective topology matrices for a matrix A and a right-hand-side vector b, (2) generating source elements for the A and the b, (3) repeatedly updating the source elements and (4) generating A and b using the respective topology matrices and the source elements.

Yet another embodiment provides a system executable on a many-core processor. In one embodiment, the system includes: (1) an input including a netlist, (2) a SPICE model evaluation module including: (2a) a setup module operable to generate topology matrices T₁ and T₂, (2b) a device evaluation/update module associated with the setup module and operable to generate and update source elements S_{A} for a matrix A and S_{b} for a right-hand-side vector b and (2c) a generation module associated with the device evaluation/update module and operable to generate A using T₁ and S_{A} and further generate b using T₂ and S_{b} and (3) an output.

### BRIEF DESCRIPTION

Reference is now made to the following descriptions taken in conjunction with the accompanying drawings, in which:

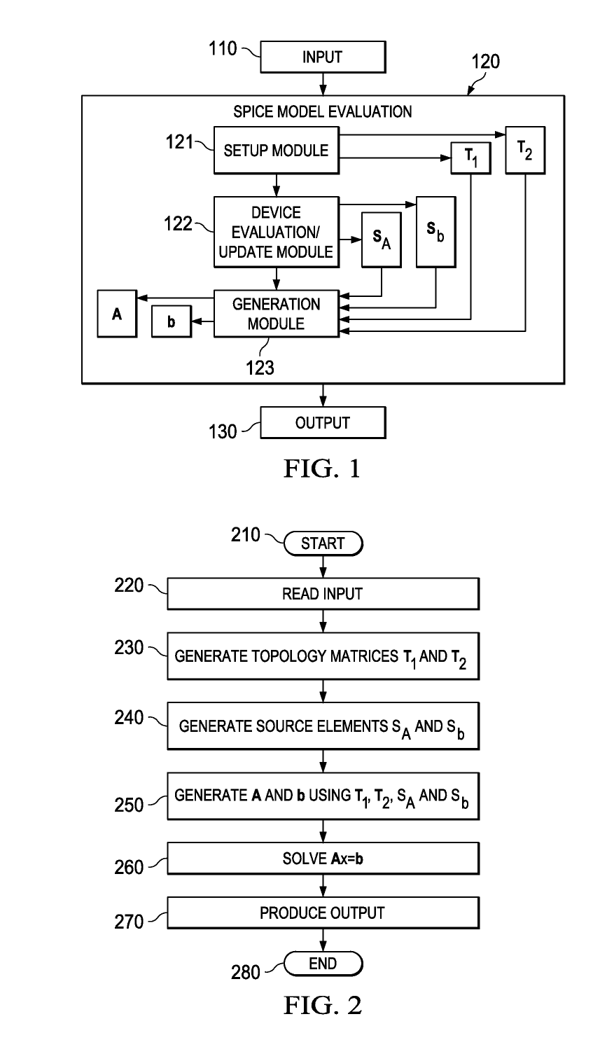

FIG. 1 is a block diagram of one embodiment of an IC simulator; and

FIG. 2 is a flow diagram of one embodiment of a method of simulating IC performance on a many-core processor.

### DETAILED DESCRIPTION

As described above, SPICE constructs a matrix A and a right-hand-side vector b for use in various (e.g., Newton-Raphson) numerical analyses. It is realized herein that carrying out SPICE on a many-core processor, such as one constructed according to Intel's MIC Architecture or Nvidia's Kepler-grade graphics processing unit (GPU) architecture, has the potential to increase SPICE's speed, because functions that can be carried out efficiently in parallel, such as matrix-vector multiplication, may be employed to advantage.

However, two significant issues arise in attempting to carry out SPICE on a many-core processor: one is reproducibility; the other is performance. Conventional SPICE interleaves the iterative evaluating of devices and updating of A. This is quite acceptable for a single-core processor, because sequential code always reproduces the same A. Further, the performance of SPICE in a single-core processor depends on the size of the cache memory, which is typically small relative to the size needed to carry out the SPICE analysis.

However, it is realized herein that the interleaving of device evaluation and matrix updating that conventional SPICE does is unacceptable in a many-core processor. More specifically, it is realized that, because a many-core processor can evaluate many devices and update many entries of A at the same time, the only way to guarantee that A is correct is to use an atomic operation. Unfortunately, not only are atomic operations computationally expensive due to their fundamentally serial nature, they cannot reproduce A. This fact will be established below.

It is realized herein that the model evaluation carried out in SPICE can be divided into three parts. A first part of the division involves constructing two topology matrices, T₁ and T₂. A second part of the division involves evaluating devices and obtaining vectors S_{A}, S_{b} which will eventually be used to generate A and b. A third part of the division involves generating matrix A and b by performing matrix-vector multiplication: A=T₁S_{A} and b=T₂S_{b}. T₁ and T₂ are almost always sparse, so the matrix-vector multiplication typically takes the form of a sparse matrix-vector multiplication.

Several advantages result from this division of SPICE's model evaluation. First, once the orientations of the currents in the circuit (using Kirchhoff's current law), and the order of devices are determined, the topology matrix need never be changed during the remainder of the evaluation. Thus, in various embodiments, T₁ and T₂ are generated only once. In some embodiments, T₁ and T₂ are generated in a central processing unit (CPU) and provided to a GPU, which carries out at least some of the subsequent evaluation. As those skilled in the pertinent art are aware, many modern SPICE implementations allow for a variable topology, meaning that the IC topology and resulting topology matrix can change before simulation begins. However, in such implementations, the simulation starts only after the topology has been “frozen,” in which case the IC topology and topology matrix do not change.

Second, the embodiments of the topology matrix illustrated herein are space-efficient, because they represent current orientation. As a result, the value of each nonzero entry is either 1 or −1, and one bit may be used to compress each value.

Third, the matrix-vector multiplication carried out in the third part of the division can be performed without atomic operations on a many-core processor, and A, the resulting matrix, is guaranteed to be reproducible. It is realized that matrix-vector multiplication is memory-bound and thus, performance decreases as the size of A increases. However, some embodiments compress A using a conventional or later-developed matrix compression technique. Compression of A allows performance to approach, and perhaps reach, optimal levels.

Fourth, the performance of matrix-vector multiplication on many-core processor is stable. Fifth, the evaluation of devices that takes place during the second part of the division can be relatively fast, because no atomic operations need be involved.

Topology matrices are known in linear algebra. They reform linear operations into matrix-vector operations which are formal, readable, understandable and amenable to numerical computation. However, topology matrices are not employed in the context of SPICE. Accordingly, topology matrices and their use in SPICE simulation will now be described more particularly.

A topology matrix is defined as follows: given a set of source elements S, a set of target elements T, and a set of operations O={f:S→T:f is linear}, a matrix-vector multiplication can represent O.

For example, if S={x₁, x₂, x₃}, T={y₁, y₂, y₃} and O={y₁+=x₁, y₁+=2*x₂, y₃+=xₓ}, the matrix-vector multiplication is:

$$[ \begin{matrix}{y}_{1} \\ {y}_{2} \\ {y}_{3}\end{matrix} ] = [ \begin{matrix}1 & 2 & 0 \\ 0 & 0 & 0 \\ 0 & 0 & 1\end{matrix} ] [ \begin{matrix}{x}_{1} \\ {x}_{2} \\ {x}_{3}\end{matrix} ] + [ \begin{matrix}{y}_{1} \\ {y}_{2} \\ {y}_{3}\end{matrix} ]$$

The above matrix-vector multiplication may be formed from O, because any scalar linear function can be represented by a dot-product. For example, f₁ is “y₁+=x₁,” and x₁ can be represented by x₁*1+x₂*0+x₃*0, or its matrix notation:

$${x}_{1} = [ \begin{matrix}1 & 0 & 0\end{matrix} ] [ \begin{matrix}{x}_{1} \\ {x}_{2} \\ {x}_{3}\end{matrix} ]$$

Sometimes it is better to use a matrix notation; sometimes it is not. A second example will now be set forth in which a matrix is employed to reform a Laplacian operator. In this example, the reformation is trivial. However, in the context of SPICE, it is far from trivial.

In a second example, a standard three-point discretization of a one-dimensional Laplacian equation

$$\frac{d u}{d {x}^{2}} = f$$

is described by the following operator form:

$${f}_{j} = \frac{{u}_{j + 1} - 2 {u}_{j} + {u}_{j - 1}}{{h}^{2}} , j = 1 , 2 , 3 , and {u}_{- 1} = {u}_{4} = 0.$$

Alternatively, a matrix-vector multiplication may represent the above operations:

$$[ \begin{matrix}{f}_{1} \\ {f}_{2} \\ {f}_{3}\end{matrix} ] = \frac{1}{{h}^{2}} [ \begin{matrix}- 2 & 1 & 0 \\ 1 & - 2 & 1 \\ 0 & 1 & - 2\end{matrix} ] [ \begin{matrix}{u}_{1} \\ {u}_{2} \\ {u}_{3}\end{matrix} ] .$$

This is a model problem in scientific computation. In this case, an explicit matrix is not required to perform matrix-vector multiplication with good performance, because parallel computing can readily avoid atomic operations.

Now the focus will shift to circuit simulation. In this case, atomic operations cannot be easily bypassed, so the teachings herein are important.

SPICE simulation involves the solution of a non-linear system of equations F(V,I)=0, where V is a vector representation of voltage nodes, and I is a vector representation of extra current branches in a given circuit. F is a vector function, and each component of F corresponds to a rule from Modified Nodal Analysis (MNA). V and I are a function of time t. Given an initial value of V(t=0) and I(t=0), V(t) and I(t) can be computed for a given time sequence t=0,t₁,t₂, . . . .

Since circuit simulation requires a non-linear system to be solved at multiple time steps, a Taylor expansion or Newton-Raphson linearization process is typically adopted to solve a succession of linear systems to extract V(tₖ) and I(tₖ) from previous values V(tₖ₋₁) and I(tₖ₋₁). Thus, the formula can be simplified by:

$$F ( V ( {t}_{k} ) , I ( {t}_{k} ) ) = F ( V ( {t}_{k - 1} ) , I ( {t}_{k - 1} ) ) + DF ( V ( {t}_{k - 1} ) , I ( {t}_{k - 1} ) ) \cdot [ \begin{matrix}V ( {t}_{k} ) - V ( {t}_{k - 1} ) \\ I ( {t}_{k} ) - I ( {t}_{k - 1} )\end{matrix} ] + h . o . t ,$$

where h.o.t stands for a “high order term,” which is neglected during the simulation. “D” is a differential operator with respect to V and I. A=DF(V(tₖ₋₁),I(tₖ₋₁)) is a square, sparse matrix. A is also assumed to be non-singular, since a singularity typically arises from a malformed netlist and represents a nonfunctional circuit or a nonsensical netlist.

Rearranging the above terms, SPICE solves the following equation for every model:

$$A \cdot [ \begin{matrix}V ( {t}_{k} ) \\ I ( {t}_{k} )\end{matrix} ] = A \cdot [ \begin{matrix}V ( {t}_{k - 1} ) \\ I ( {t}_{k - 1} )\end{matrix} ] - F ( V ( {t}_{k - 1} ) , I ( {t}_{k - 1} ) ) \text{<=} \text{>} Given A and b , solve Ax = b .$$

Because the well-known Kirchhoff's current law requires currents orientation, each component of F can be regarded as the linear combination of several device models, e.g.:

$${F}_{j} ( V , I ) = {\sum }_{k} {α}_{k} {f}_{k}^{j} ( V , I ) ,$$

where αₖ={1,−1} denotes the orientation of the current in a current branch, and fₖ^{j}(V,I) is a function (linear or nonlinear), including the extra current branches.

In one example of a circuit having a MOSFET, the linear system resulting from Newton-Raphson linearization is:

$$[ \begin{matrix}{Df}_{10} & 0 & {Df}_{31} & 1 & 0 \\ 0 & - {Df}_{20} - {Df}_{32} & {Df}_{32} & 0 & 0 \\ {Df}_{31} & {Df}_{32} & - {Df}_{31} - {Df}_{32} & 0 & 1 \\ 1 & 0 & 0 & 0 & 0 \\ 0 & 0 & 1 & 0 & 0\end{matrix} ] [ \begin{matrix}{V}_{1} \\ {V}_{2} \\ {V}_{3} \\ {I}_{1} \\ {I}_{2}\end{matrix} ] = [ \begin{matrix}- {f}_{31} - {f}_{10} \\ {f}_{31} + {f}_{32} \\ {f}_{20} + {f}_{32} \\ {V}_{S} \\ {V}_{DD}\end{matrix} ] ,$$

where scalar functions f₁₀, f₃₁, f₂₀ and f₃₂ describe linear or non-linear relationships between current branches and voltage nodes. V_{S} and V_{DD} are known values for the IC.

To solve the above linear system Ax=b, A needs to be updated with Df₁₀, Df₃₁, Df₂₀ and Df₃₂, and b needs to be updated with f₁₀, f₃₁, f₂₀ and f₃₂.

Before describing the difference between the topology matrix method disclosed herein and the conventional technique in this example, some notation should be introduced. First, A is represented by:

$$A = [ \begin{matrix}{a}_{11} & 0 & {a}_{13} & {a}_{14} & 0 \\ 0 & {a}_{22} & {a}_{23} & 0 & 0 \\ {a}_{31} & {a}_{32} & {a}_{33} & 0 & {a}_{35} \\ {a}_{41} & 0 & 0 & 0 & 0 \\ 0 & 0 & {a}_{53} & 0 & 0\end{matrix} ] .$$

In one embodiment, non-zero elements are stored in row-major order. In another embodiment, non-zero elements are stored in column-major order. The vectors x and b are represented as follows:

$$x = [ \begin{matrix}{x}_{1} \\ {x}_{2} \\ {x}_{3} \\ {x}_{4} \\ {x}_{5}\end{matrix} ] , b = [ \begin{matrix}{b}_{1} \\ {b}_{2} \\ {b}_{3} \\ {b}_{4} \\ {b}_{5}\end{matrix} ] .$$

The conventional technique for updating A is to write corresponding values to nonzero elements a₁₁, a₃₁, a₄₁, a₂₂, a₃₂, a₁₃, a₂₃, a₃₃, a₅₃, a₁₄ and a₃₅ in some sequential order. If the original sequential program is trivially transformed into its parallel counterpart (“parallelized”), several issues arise:

First, atomic operation is necessary. As an example, a₂₂+=−Df₂₀−Df₃₂ employs two threads: one thread performs a₂₂=a₂₂−Df₂₀, and the other thread performs a₂₂=a₂₂−Df₃₂. The two threads are running in parallel, but only one thread can update a₂₂ at any instant in time. Thus, an atomic operation is needed to avoid a race condition. An atomic operation carries out a read-modify-write operation in a non-interrupted unit. Atomic operations are relatively slow.

Second, the result cannot be reproduced. Again, taking a₂₂+=−Df₂₀−Df₃₂ as an example, two results are possible, depending upon which thread updates a₂₂ first: a₂₂−Df₃₂−Df₂₀ or a₂₂−Df₂₀−Df₃₂. The two results are theoretically equivalent, however if a₂₂ is nonzero, rounding error may cause them to be different in practice. Those skilled in the pertinent art will recall that rounding error is a consequence of finite precision computation. In other words, if a, b and c are floating point numbers, (a+b+c) may not be equal to (a+c+b).

Third, performance may not be stable. The performance depends on the pattern of memory access, including Df_{w}, Df₃₁, Df₂₀, Df₃₂, a₁₁, a₃₁, a₄₁, a₂₂, a₃₂, a₁₃, a₂₃, a₃₃, a₅₃, a₁₄ and a₃₅. The pattern depends on the order of threads which are running in parallel, so the threads cannot be expected to run in the same order every time.

Fourth, performance is likely not to be good. The required atomic updates are known to hamper performance.

Turning to the topology matrix method disclosed herein, a topology matrix T₁ is generated for A, and a topology matrix T₂ is generated for b. To generate the topology matrix T₁, a set of source elements S={Df₁₀,Df₂₀,Df₃₁,Df₃₂,1}, a set of target elements T={a₁₁,a₃₁,a₄₁,a₂₂,a₃₂,a₁₃,a₂₃,a₃₃,a₅₃,a₁₄,a₃₅} and a set of operations

$$O = \{ \begin{matrix}{a}_{11} = {Df}_{10} , {a}_{31} = {Df}_{31} , {a}_{41} = 1 , {a}_{22} = - {Df}_{20} - {Df}_{32} , {a}_{32} = {Df}_{32} , \\ {a}_{13} = {Df}_{31} , {a}_{23} = {Df}_{32} , {a}_{33} = - {Df}_{31} - {Df}_{32} , {a}_{53} = 1 , {a}_{14} = 1 , {a}_{35} = 1\end{matrix} \} ,$$

are defined. The relation T=T₁*S can then be represented by:

$$[ \begin{matrix}{a}_{11} \\ {a}_{31} \\ {a}_{41} \\ {a}_{22} \\ {a}_{32} \\ {a}_{13} \\ {a}_{23} \\ {a}_{33} \\ {a}_{53} \\ {a}_{14} \\ {a}_{35}\end{matrix} ] = ( {T}_{1} = [ \begin{matrix}1 & & & & \\ & & 1 & & \\ & & & & 1 \\ & - 1 & & - 1 & \\ & & & 1 & \\ & & 1 & & \\ & & & 1 & \\ & & - 1 & - 1 & \\ & & & & 1 \\ & & & & 1 \\ & & & & 1\end{matrix} ] ) [ \begin{matrix}{Df}_{10} \\ {Df}_{20} \\ {Df}_{31} \\ {Df}_{32} \\ 1\end{matrix} ] + [ \begin{matrix}{a}_{11} \\ {a}_{31} \\ {a}_{41} \\ {a}_{22} \\ {a}_{32} \\ {a}_{13} \\ {a}_{23} \\ {a}_{33} \\ {a}_{53} \\ {a}_{14} \\ {a}_{35}\end{matrix} ] .$$

Similarly, the topology matrix T₂ for b is:

$$[ \begin{matrix}{b}_{1} \\ {b}_{2} \\ {b}_{3} \\ {b}_{4} \\ {b}_{5}\end{matrix} ] = ( T 2 = [ \begin{matrix}- 1 & & - 1 & & & \\ & & 1 & 1 & & \\ & 1 & & 1 & & \\ & & & & 1 & \\ & & & & & 1\end{matrix} ] ) [ \begin{matrix}{f}_{10} \\ {f}_{20} \\ {f}_{31} \\ {f}_{32} \\ {V}_{S} \\ {V}_{DD}\end{matrix} ] + [ \begin{matrix}{b}_{1} \\ {b}_{2} \\ {b}_{3} \\ {b}_{4} \\ {b}_{5}\end{matrix} ] .$$

FIG. 1 is a block diagram of one embodiment of an IC simulator. The IC simulator is configured to receive input 110 describing an IC design. In one embodiment, the input 110 takes the form of a netlist. In other embodiments, the input 110 takes the form of other conventional or later-developed IC description techniques. In the illustrated embodiment, SPICE model evaluation module 120 includes a setup module 121, a device evaluation/update module 122 and a generation module 123 operable to carry out the following steps:

Step 1: The setup module 121 is operable to generate topology matrices T₁ and T₂.

Step 2: The device evaluation/update module 122 is operable to generate source elements S_{A}={Df₁₀,Df₂₀,Df₃₁,Df₃₂,1} for A and S_{b}={f₁₀,f₂₀,f₃₁,f₃₂,V_{S},V_{DD}} for b.

Step 3: The generation module 123 is operable to perform sparse matrix-vector multiplication (e.g., csrmv) as follows:

csc(A)=T₁*S_{A} and b=T₂*S_{b},

where csc(A) is a column-major order of non-zero elements in A. In the example, csc(A)={a₁₁,a₃₁,a₄₁,a₂₂,a₃₂,a₁₃,a₂₃,a₃₃,a₅₃,a₁₄,a₃₅}.

The SPICE model evaluation module 120 produces output 130, which may take the form of logs.

In contrast to the conventional technique described above, atomic operation is unnecessary in the matrix-vector multiplication y=A*x. Results are reproducible. Performance is stable assuming a deterministic algorithm is employed to perform the matrix-vector multiplication. While matrix-vector multiplication is memory-bound, a topology matrix is relatively memory-efficient because it represents orientation of the currents. Consequently, only one bit is required to represent each value, allowing performance to come close to speed-of-light.

Finally, the topology matrix is particularly advantageous in the context of SPICE, because it is one-time cost. Topology matrices can be generated at the beginning, before doing simulation. During the simulation, source elements S_{A}={Df₁₀,Df₂₀,Df₃₁,Df₃₂,1} for A and S_{b}={f₁₀,f₂₀,f₃₁,f₃₂,V_{S},V_{DD}} for b are updated (recalculated) by the SPICE model evaluation process.

FIG. 2 is a flow diagram of one embodiment of a method of simulating IC performance on a many-core processor. The method begins in a start step 210. In a step 220, input is read. In a step 230, topology matrices T₁ and T₂ are generated for A and b, respectively. In a step 240, source elements S_{A} and S_{b} are generated and repeatedly updated as devices in the IC are analyzed. In a step 250, A and b are generated using T₁, T₂, S_{A} and S_{b}. In a step 260, Ax=b is solved. Output is then produced in a step 270. The method ends in an end step 280.

Those skilled in the art to which this application relates will appreciate that other and further additions, deletions, substitutions and modifications may be made to the described embodiments.

What is claimed is:

1. A SPICE model evaluation module executable on a many-core processor and comprising:
a setup module operable to generate topology matrices T₁ and T₂;
a device evaluation/update module associated with said setup module and operable to generate and update source elements S_{A} for a matrix A and S_{b} for a right-hand-side vector b; and
a generation module associated with said device evaluation/update module and operable to generate said A using said T₁ and said S_{A} and further generate said b using said T₂ and said S_{b}.

2. The module as recited in claim 1 wherein said generation module is further operable to solve Ax=b.

3. The module as recited in claim 1 further comprising an input coupled to said SPICE model evaluation module and configured to provide a netlist thereto.

4. The module as recited in claim 1 wherein said generation module is further operable to generate said A and said b by performing a matrix-vector multiplication.

5. The module as recited in claim 1 wherein said topology matrices contain elements Δₖ={1,−1}.

6. The module as recited in claim 1 wherein said device evaluation/update module is configured to generate and update said source elements S_{A} and S_{b} absent atomic operations.

7. The module as recited in claim 1 wherein said T₁ and said T₂ are sparse.

8. A method of simulating IC performance on a many-core processor, comprising:
generating respective topology matrices for a matrix A and a right-hand-side vector b;
generating source elements for said A and said b;
repeatedly updating said source elements; and
generating said A and said b using said respective topology matrices and said source elements.

9. The method as recited in claim 8 further comprising solving Ax=b.

10. The method as recited in claim 8 further comprising reading a netlist.

11. The method as recited in claim 8 wherein said generating said A and said b comprises performing a matrix-vector multiplication.

12. The method as recited in claim 8 wherein said topology matrices contain elements αₖ={1,−1}.

13. The method as recited in claim 8 wherein said repeatedly updating is carried out absent atomic operations.

14. The method as recited in claim 8 wherein said T₁ and said T₂ are sparse.

15. A system executable on a many-core processor and comprising:
an input including a netlist;
a SPICE model evaluation module including:
a setup module operable to generate topology matrices T₁ and T₂,
a device evaluation/update module associated with said setup module and operable to generate and update source elements S_{A} for matrix A and S_{b} for a right-hand-side vector b, and
a generation module associated with said device evaluation/update module and operable to generate said A using said T₁ and said S_{A} and further generate said b using said T₂ and said S_{b}; and
an output.

16. The system as recited in claim 15 wherein said generation module is further operable to solve Ax=b.

17. The system as recited in claim 15 wherein said generation module is further operable to generate said A and said b by performing a matrix-vector multiplication.

18. The system as recited in claim 15 wherein said topology matrices contain elements αₖ={1,−1}.

19. The system as recited in claim 15 wherein said device evaluation/update module is configured to generate and update said source elements S_{A} and S_{b} absent atomic operations.

20. The system as recited in claim 15 wherein said T₁ and said T₂ are sparse.
